(19) United States
(12) Patent Application Publication
(10) Pub. No.: US 2026/0180150 A1
(43) Pub. Date: Jun. 25, 2026

(54) FIRE RESPONSE APPARATUS FOR ROOF-MOUNTED ELECTRIC VEHICLE BATTERIES

(71) Applicants: Hyundai Motor Company, Seoul (KR); Kia Corporation, Seoul (KR)

(72) Inventors: Jung Mungi, Hwaseong (KR); Yun Nam Seok, Hwaseong (KR)

(21) Appl. No.: 19/201,185

(22) Filed: May 7, 2025

(30) Foreign Application Priority Data
Dec. 19, 2024 (KR) 10-2024-0191609

(51) Int. Cl. H01M 50/609; H01M 50/249; H01M 50/383; H01M 50/682

(52) U.S. Cl. CPC H01M 50/609; H01M 50/249; H01M 50/383; H01M 50/682; H01M 2200/10; H01M 2220/20

(57) ABSTRACT

A fire response apparatus for roof-mounted electric vehicle batteries includes a mount frame that supports a battery pack, surrounded by vertical columns. The vertical columns extend upward to support a skeletal frame positioned above the battery pack. A water storage wall is fixed to the skeletal frame, enclosing an area below it, while a water storage barrier connected to the lower end of the wall forms a bottom surface. A controller is configured to release a fire extinguishing liquid into a water storage structure when a specific condition is detected, thereby ensuring that the battery pack is safely enclosed within a water reservoir for effective fire suppression.

### CROSS-REFERENCE TO RELATED APPLICATION(S)

This application claims under 35 U.S.C. § 119(a) the benefit of Korean Patent Application No. 10-2024-0191609, filed on Dec. 19, 2024 in the Korean Intellectual Property Office, the entire contents of which are incorporated by reference herein.

### BACKGROUND

### (a) Technical Field

The present disclosure relates to a fire response apparatus for roof-mounted electric vehicle batteries, more particularly, to the fire response apparatus for roof-mounted electric vehicle batteries that enables each battery pack to be submerged in a fire extinguishing liquid in an emergency even if a battery pack system is mounted on the upper part of a vehicle body, such as in an electric bus.

### (b) Description of the Related Art

Electric vehicles are rapidly replacing conventional internal combustion engines in a variety of applications.

The capacity of battery systems is still technically limited, and there are also restrictions on the voltage level that may be utilized through the battery systems.

Nevertheless, electric vehicles are environmentally friendly and have high energy efficiency compared to internal combustion engines, and various policy support and assistance are focused thereon worldwide.

Electric vehicles are now leading changes in the automobile industry, and are not limited to small-scale electrical driving devices but are also being applied to large-scale equipment with high energy consumption.

Lithium-ion batteries, which are widely used in electric vehicles, are efficient because they have high energy density. However, lithium-ion batteries also have the disadvantage of being somewhat vulnerable to high temperatures or impacts.

In rare cases, a battery system installed in an electric vehicle may overheat. In this case, it is known that submerging the battery system in a fire extinguishing liquid is an effective measure to prevent secondary accidents caused by battery overheating.

However, in cases in which a battery pack system is not placed in the lower portion of a vehicle but is installed on the roof of the vehicle, such as in electric buses, there is a structural limitation that makes it difficult to quickly submerge a battery pack in a fire extinguishing liquid upon overheating.

Therefore, technology to solve these problems is required.

### SUMMARY

Therefore, the present disclosure addresses a problem in which a dedicated water storage had to be installed separately so as to extinguish a fire that may occur secondarily due to overheating of the batteries of an electric vehicle and thereby increase in the overall load and a narrower vehicle body space were caused.

The present disclosure also addresses a problem in which it was insufficient to detect and respond to heat generation of some batteries in a special situation where batteries are installed on the upper portion of a vehicle, such as in an electric vehicle.

The present disclosure further addresses a problem in which it was difficult to additionally install a fire prevention structure capable of storing a fire extinguishing liquid around batteries of an electric bus, because a battery pack system must be formed in a structure that is advantageous for cooling and is capable of easily discharging dust and foreign substances when the electric bus is driven.

The objects of the present disclosure are not limited to the above-described objects, and other objects or tasks not mentioned herein will be understood from the following description.

In accordance with the present disclosure, the above and other objects can be accomplished by the provision of a fire response apparatus for roof-mounted electric vehicle batteries including a battery pack of an electric vehicle, a mount frame configured such that the battery pack is placed thereon to be connected thereto, a plurality of vertical columns configured to extend upward from the mount frame along an outer circumference of the battery pack, a skeletal frame coupled to upper ends of the plurality of vertical columns and disposed higher than the battery pack while surrounding a wider area than the battery pack, a water storage wall formed of a waterproof material and configured to have an upper end fixed along the skeletal frame and surround an area under the skeletal frame in all directions, a water storage barrier formed of a waterproof material and configured to have an outer circumference connected to a lower end of the water storage wall to form a bottom surface, and a controller configured to supply a fire extinguishing liquid to a water storage structure formed by the water storage wall and the water storage barrier when a predetermined condition is detected, wherein the battery pack is disposed within the water storage structure.

According to an aspect of the present disclosure, a fire response apparatus for roof-mounted electric vehicle batteries includes: a battery pack of an electric vehicle; a mount frame configured to receive and support the battery pack such that the battery pack is electrically connected to the mount frame; a plurality of vertical columns extending from the mount frame; a skeletal frame coupled to the plurality of vertical columns; a water storage wall being fixed to the skeletal frame and configured to surround an area beneath the skeletal frame; and a controller configured to supply a fire extinguishing liquid to the water storage structure upon detection of a predetermined condition, wherein the battery pack is disposed within the water storage structure.

The fire response apparatus may further include a water storage barrier formed of a waterproof material, the water storage barrier having an outer circumference connected to a lower end of the water storage wall to form a bottom surface of a water storage structure.

The water storage barrier may include a coupling surface formed to have a predetermined area and coupled to a lower end of the mount frame through a plurality of coupling modules to be formed as a flat surface, and the plurality of coupling modules configured to connect the coupling surface to the lower end of the mount frame may extend vertically downward and be coupled to a roof of a body of the electric vehicle.

The mount frame may be stacked on another mount frame by coupling the coupling modules configured to extend downward from the coupling surface to the upper ends of the plurality of vertical columns connected to the other mount frame.

The water storage wall may include at least one open port formed in one side surface of the water storage wall to be opened with a predetermined area, and a water shield provided at an inner upper end of the open port to close the open port when a surrounding temperature becomes higher than a predetermined value.

The water shield may include a wall connector provided with an area wider than a width of the open port and coupled to a position higher than a position where the open port is formed among an inner surface of the water storage wall, an attractive adhesive part provided along a lower end of the open port on an outer surface of the water storage wall, a corresponding adhesive part provided in a horizontal direction at a lower end of the water shield to form attractive force with the attractive adhesive part, and a melting member configured to roll the water shield upward inside the water storage wall and break at a predetermined temperature to deploy the water shield.

The water shield may further include a pair of strip springs provided in a vertical direction at both side ends of the water shield and elastically restored to deploy the water shield if external force is removed.

The skeletal frame may include a support frame formed as a rectangular frame above an upper portion of the battery pack, and a fastening holder formed as a flat plane along an outer circumference of the support frame and provided with a plurality of fastening holes formed at predetermined intervals, the water storage wall may include a plurality of coupling holes formed in an upper fastening end formed along an upper end of the water storage wall at intervals corresponding to the fastening holes, and the coupling holes and the fastening holes may be coupled to each other through fastening members.

The water storage wall may further include a lower molding end formed with a predetermined width along a lower end of the water storage wall, the water storage barrier may include a molding border formed with a predetermined width along an outer circumference of the water storage barrier, and the fire response apparatus may further include a molding frame coupled to the lower molding end in a horizontal direction and coupled to the molding border in a vertical direction.

The molding frame may be provided as a rectangular frame corresponding to the support frame and include a vertical coupler having an opening opened upward and formed in a longitudinal direction so that at least a portion of the lower molding end is inserted thereinto to be coupled to the vertical coupler, and a horizontal coupler having an opening opened inward and formed in the longitudinal direction so that at least a portion of the molding border is inserted thereinto to be coupled to the horizontal coupler.

The molding frame may further include a plurality of horizontal rivets configured to pass through the lower molding end inserted into the opening of the vertical coupler to couple the lower molding end to the vertical coupler, and a plurality of vertical rivets configured to pass through the molding border inserted into the opening of the horizontal coupler to couple the molding border to the horizontal coupler.

The molding frame may further include a high-rigidity shape maintainer having a high elastic modulus to be less deformed by external force and configured to connect the vertical coupler and the horizontal coupler so as to be perpendicular to each other in the molding frame formed in a border shape.

The water storage barrier may further include a corresponding deformation surface provided as a surface formed between an outer circumference of the coupling surface and an outer circumference of the water storage barrier connected to a lower end of the water storage wall, and configured such that at least a partial section of the corresponding deformation surface between the coupling surface and the outer circumference of the water storage barrier is formed as a curved surface.

The corresponding deformation surface may include a drainage port formed adjacent to the outer circumference of the coupling surface and opened with a predetermined size, and a shield coupled to an upper side of the corresponding deformation surface along one side configured to face the coupling surface among the outer circumference of the drainage port to close the drainage port in a predetermined situation.

According to another aspect of the present disclosure, a vehicle may include the fire response apparatus.

According to a further aspect of the present disclosure, a fire response apparatus for roof-mounted electric vehicle batteries includes: a battery pack of an electric vehicle; a mount frame configured to receive and support the battery pack such that the battery pack is electrically connected to the mount frame; a plurality of vertical columns extending upward from the mount frame along an outer circumference of the battery pack; a skeletal frame coupled to upper ends of the plurality of vertical columns, the skeletal frame being positioned above the battery pack and surrounding an area wider than the battery pack; a water storage wall formed of a waterproof material, having an upper end fixed to the skeletal frame and configured to surround an area beneath the skeletal frame in all directions; and a controller configured to supply a fire extinguishing liquid to the water storage structure upon detection of a predetermined condition, wherein the battery pack is disposed within the water storage structure.

The fire response apparatus may further include a water storage barrier formed of a waterproof material, the water storage barrier having an outer circumference connected to a lower end of the water storage wall to form a bottom surface of a water storage structure.

### BRIEF DESCRIPTION OF THE DRAWINGS

The above and other objects, features and other advantages of the present disclosure will be more clearly understood from the following detailed description taken in conjunction with the accompanying drawings, in which:

FIGS. 1 and 2 are perspective and front views, respectively, schematically illustrating a fire response apparatus for roof-mounted electric vehicle batteries according to one embodiment of the present disclosure;

FIGS. 3 and 4 are perspective views illustrating a state in which a battery pack is coupled to a mount frame so as to be mountable on a roof in the fire response apparatus for roof-mounted electric vehicle batteries according to one embodiment of the present disclosure;

FIGS. 5 to 7 are views illustrating a process of installing the battery pack in a space surrounded by a water storage barrier and a water storage wall in the fire response apparatus for roof-mounted electric vehicle batteries according to one embodiment of the present disclosure;

FIG. 8 is a cross-sectional view illustrating the internal structure of the fire response apparatus for roof-mounted electric vehicle batteries according to one embodiment of the present disclosure;

FIG. 9 is a partial enlarged view illustrating portion A of FIG. 8;

FIG. 10 is a partial enlarged view illustrating portion B of FIG. 8;

FIG. 11 is a partial enlarged view illustrating portion C of FIG. 8;

FIG. 12 is a partial cross-sectional view illustrating the structure of a shield installed at a drainage port in a roof-mounted electric vehicle battery according to one embodiment of the present disclosure;

FIG. 13 is a cross-sectional view illustrating the structure of a water shield installed at an open port in the roof-mounted electric vehicle battery according to one embodiment of the present disclosure; and

FIG. 14 is a schematic view illustrating a principle of forming a water storage space so that an extinguishing liquid is stored therein in roof-mounted electric vehicle battery according to one embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to the exemplary embodiments of the present disclosure, examples of which are illustrated in the accompanying drawings.

Wherever possible, the same reference numbers will be used throughout the drawings to refer to the same or similar components, and a redundant description thereof will be omitted.

When an element or layer is referred to as being “connected to” or “coupled to” another element or layer, it may be directly connected to or coupled to the other element or layer, or intervening elements or layers may be present.

In contrast, when an element is referred to as being “directly connected to” or “directly coupled to” another element or layer, there may be no intervening elements or layers present.

In addition, a first direction (X-axis direction), a second direction (Y-axis direction), and a third direction (Z-axis direction) stated in the following description are used to describe a three-dimensional shape in a three-dimensional space, and indicate directions that are orthogonal to each other.

The present disclosure relates to a fire response apparatus for roof-mounted electric vehicle batteries.

The present disclosure proposes, because a battery pack system is mounted on a roof 100 of the body of an electric bus 1 in most cases and a method of quickly suppressing heat generation or fire in the battery pack system mounted on the roof 1 of the electric bus 1 is required, a technical feature that quickly stabilizes the battery pack system in such an environment.

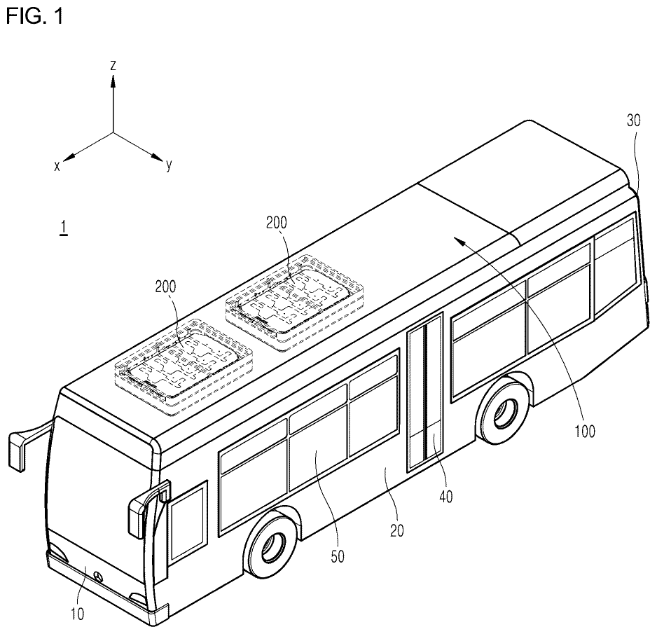

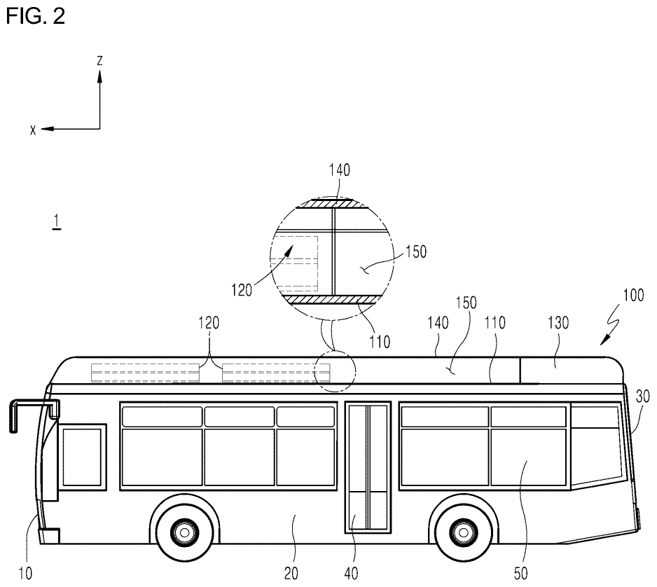

FIGS. 1 and 2 are perspective and front views schematically illustrating a fire response apparatus for roof-mounted electric vehicle batteries according to one embodiment of the present disclosure.

As shown in FIGS. 1 and 2, the electric bus 1 generally has a wide body in which both long side surfaces 20 extend longitudinally between a front surface 10 and a rear surface 30, and has a high overall height because the roof 100 of the electric bus 1 is provided at a high position.

The electric bus 1 may generally have various hardware, such as the battery pack system, an air conditioning system, and a communication system, installed in an utility space 150 formed on the roof 100.

The drawings briefly illustrate that pack loading parts 120 are provided in the utility space 150 between a base panel 110 configured to form the bottom surface of the roof 100, side panels configured to form the side walls of the roof 100, and a top cover 140 configured to form the ceiling surface of the roof 100.

As illustrated, depending on an embodiment to which the present disclosure is applied, battery packs 200 may be stacked in at least two layers while being mounted in the pack loading part 120, and may be stably installed at a set position in the space of the roof 100 of the electric bus 1.

The fire response apparatus according to one embodiment of the present disclosure may include the battery pack 200, a mount frame 300, a plurality of vertical columns 310, a skeletal frame 400, a water storage wall 600, a water storage barrier 500, and a controller.

The battery pack 200 is formed by accommodating a plurality of battery modules in a housing having a predetermined size. Each battery module is formed by stacking and combining a plurality of battery cells in multiple layers.

The mount frame 300 may be formed as a linear frame that may form a space in which the battery pack 200 may be placed, and surround and protect at least a portion of the outer circumference of the battery pack 200.

Each battery pack 200 may include a terminal forming part formed on the outer surface thereof to transmit and receive an electrical signal and/or data signal.

In addition, cooling plates for cooling may be installed on the upper and lower surfaces of the battery pack 200, and a pair of installation terminals 210 that extend outwardly in parallel may be provided on both side walls of the battery pack 200.

A plurality of mounting units may be formed on the installation terminals 210 so as to be connected to an external structure.

In one embodiment of the present disclosure, the mount frame 300 may be formed as a rectangular frame or a plate-shaped member to correspond to the outer shape of each battery pack 200. The installation terminals 210 protruding in the longitudinal direction from both side ends of the battery pack 200 are respectively coupled to the mount frame 300 so as to be supported by both sides of of the mount frame 300.

The mount frame 300 may include the plurality of vertical columns 310 arranged along the outer perimeter of the battery pack 200. The lower ends of the vertical columns 310 are connected to the upper surface of the mount frame 300, and the vertical columns 310 extend vertically upward by a designated length. A plane formed horizontally may be formed at the upper end of each of the vertical columns 310, and a connection structure provided in various forms, such as a bolt coupling hole and an insertion coupling hole, may be provided in the plane of the upper end of the vertical column 310 depending on the embodiment to which the present disclosure is applied.

The mount frame 300 mounts each battery pack 200 on the roof 100 of the electric bus 1 while stably fixing the battery pack 200.

Mount frames 300 may be installed in a stacked structure having at least two layers through the vertical columns 310 while the battery pack 200 is fixedly mounted on each mount frame 300.

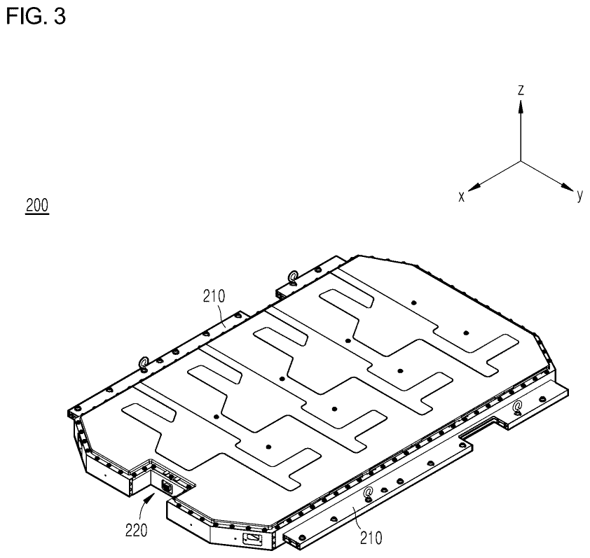

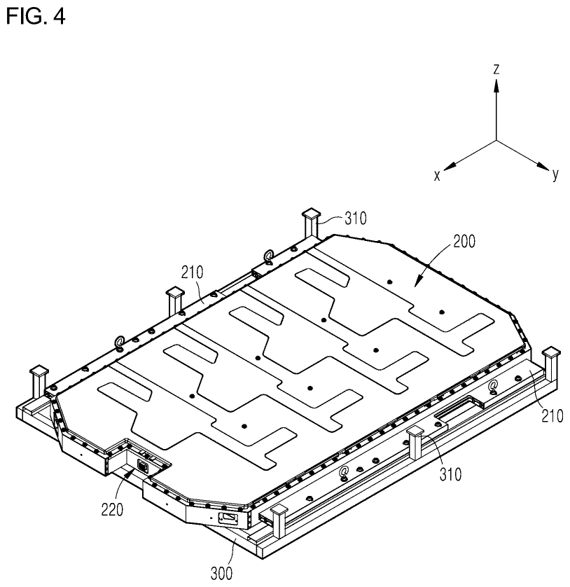

FIGS. 3 and 4 are perspective views illustrating a state in which the battery pack 200 is coupled to the mount frame 300 so as to be mountable on the roof 100 in the fire response apparatus for roof-mounted electric vehicle batteries according to one embodiment of the present disclosure.

As shown in FIGS. 3 and 4, each battery pack 200 may be fixedly mounted on the mount frame 300. The mount frame 300 may be formed to surround the outer circumference of the lower end of each battery pack 200. Alternatively, as described above, the mount frame 300 may be formed in a plate shape along the lower portion of the battery pack 20, a rigid structure may be provided along the outer edge of the plate-shaped surface of the mount frame 300, and a plurality of openings may be formed in the plate-shaped surface of the mount frame 300.

The plurality of vertical columns 310 extend upward from the outer end of the mount frame 300 along the outer circumference of the battery pack 200, and the upper ends of the vertical columns extend to a position higher than the thickness of each battery pack 200.

The mount frame 300 may be formed of a high-strength metal material, such as an aluminum alloy or metal. The mount frame 300 may be designed with a material that is advantageous for weight reduction and has high corrosion resistance.

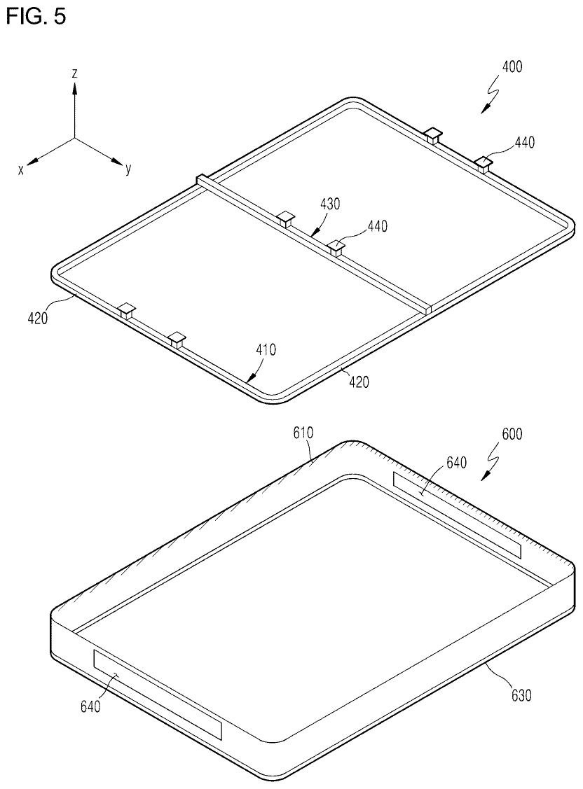

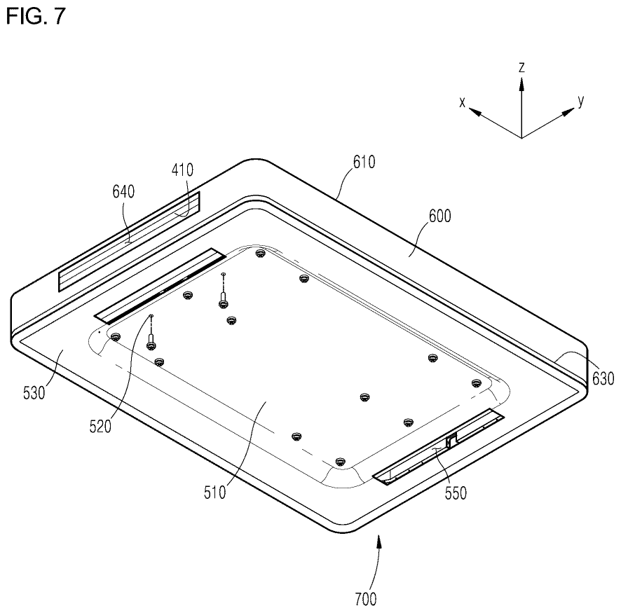

FIGS. 5 to 7 are views illustrating a process of installing the battery pack 200 in a space surrounded by the water storage barrier 500 and the water storage wall 600 in the fire response apparatus for roof-mounted electric vehicle batteries according to one embodiment of the present disclosure.

As shown in FIGS. 5 to 7, the skeletal frame 400 is provided above the upper portion of the mount frame 300. The skeletal frame 400 may include a support frame 410 and a fastening holder 420.

The skeletal frame 400 may be coupled to the upper ends of the plurality of vertical columns 310. The skeletal frame 400 is formed to surround a wider area than the battery pack 200, and is horizontally disposed at a higher position than the battery pack 200.

Each battery pack 200 is a structure configured such that the upper portion thereof is protected by the skeletal frame 400 and the lower portion thereof is supported by the mount frame 300, and may be stably mounted in the pack loading part 120 formed to be stably fixed to the roof 100.

The support frame 410 of the skeletal frame 400 is formed as a rectangular or square frame around the upper perimeter of the battery pack 200, and is formed to have a wider area than the entire outline of each battery pack 200.

The fastening holder 420 is a plane formed in lateral direction to have a constant vertical width along the outer circumference of the support frame 410, and an upper fastening end 610 provided at the upper end of the water storage wall 600 is coupled to the plane of the fastening holder 420.

The skeletal frame 400 may further include a reinforcing member 430, and the reinforcing member 430 may be formed to traverse the support frame 410 or to connect some bent corners of the support frame 410, thereby increasing the structural rigidity of the skeletal frame 400.

In addition, each reinforcing frame and/or the support frame 410 may be provided with multiple expansion modules 440 that extend upward. The expansion modules 440 may be used to stack the pack loading part 120, be coupled to an external structure, install an additional device, etc.

The water storage wall 600 may include the upper fastening end 610 formed to have a predetermined width along the upper end thereof.

The upper fastening end 610 of the water storage wall 600 is attached to the fastening holder 420 of the skeletal frame 400 to be in surface contact therewith. The surface of the fastening holder 420 and the surface of the upper fastening end 610 may be attached using an adhesive film or an adhesive.

Alternatively, a plurality of fastening holes may be formed at predetermined intervals in the fastening holder 420, which is a belt-shaped surface formed along the outer circumference of the support frame 410, and correspondingly, a plurality of coupling holes may be formed at the predetermined intervals in the longitudinal direction in the upper fastening end 610.

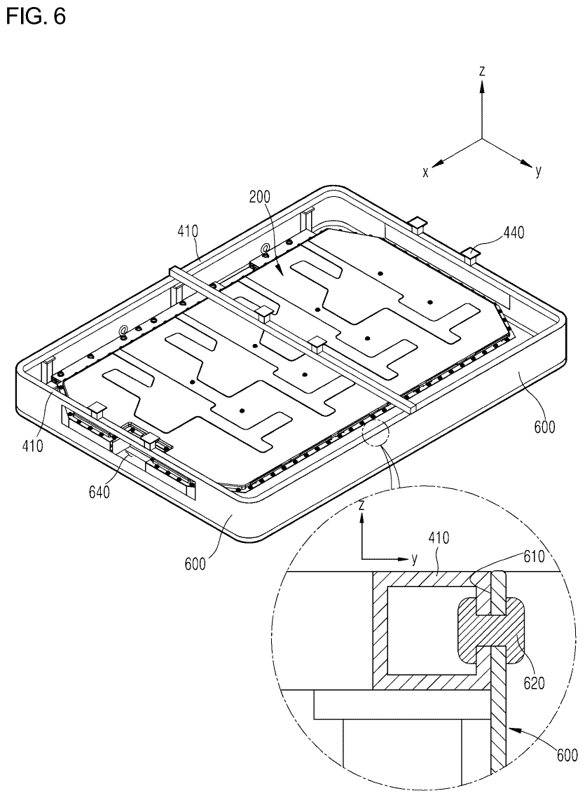

As shown in FIG. 6, the fastening holder 420 and the upper fastening end 610 may face each other and be firmly coupled through fastening members 620.

The water storage wall 600 may be formed of a waterproof fabric. In addition, the water storage wall 600 may be formed of a material that has high thermal insulation performance and high waterproof performance and is robust enough not to be easily torn or punctured.

As the upper fastening end 610 formed long along the upper end of the water storage wall 600 is coupled to the outer circumference of the skeletal frame 400, the water storage wall 600 is disposed under the skeletal frame 400 in a form that surrounds a space corresponding to the shape of the skeletal frame 400.

At least one open port 640 may be formed to have a constant length in the vertical direction from the upper fastening end 610 of the water storage wall 600.

The open port 640 is an open space formed in the water storage wall 600 to have a predetermined size, and may be formed to enable devices, such as electrical cables, data cables, and refrigerant channels, to pass therethrough, ventilate the space where the battery pack 200 is installed, and discharge foreign substances from the space.

The water storage wall 600 is provided with a lower molding end 630 formed long along the lower end thereof.

The lower molding end 630 forms a section having a certain width along the lower end of the water storage wall 600.

A thin film-type steel material may be inserted into the lower molding end 630 to further increase the rigidity of the lower molding end 630.

The water storage barrier 500 has a molding border 540 formed along the outer circumference thereof. The molding border 540 is formed continuously to have a predetermined width like the lower molding end 630, and may be formed such that a film-type steel material is inserted into the molding border 540.

The water storage barrier 500 is connected to the lower molding end 630 formed along the lower end of the water storage wall 600 through a molding frame 700. Thereby, the water storage barrier 500 may be formed as a predetermined floor surface having the outer circumference connected to the lower end of the water storage wall 600.

The water storage barrier 500 may also be formed of a waterproof fabric, and the fabric may be selected to have high thermal performance and durability.

The controller collects predetermined data including the state of the battery pack 200. Then, when a predetermined situation occurs based on the collected data, as described above, the controller supplies a fire extinguishing liquid to a water storage structure formed by the water storage wall 600 and the water storage barrier 500 while the battery pack 200 is mounted therein.

The fire extinguishing liquid is supplied to a height where the battery pack 20 may be completely submerged.

The water storage barrier 500 is formed of a waterproof and thermally insulating fabric that is widely disposed in the horizontal direction.

The water storage barrier 500 includes a coupling surface 510 including a central portion and formed around the central portion, and a corresponding deformation surface 530, which is an area between the outer perimeter of the coupling surface 510 and the molding border 540.

A plurality of fixing holes 520 is formed in the coupling surface 510, and each fixing hole 520 may be coupled to a corresponding one of lower fastening holes formed in the mount frame 300 through an extension coupling module 800.

That is, the plurality of fixing holes 520 is formed in the coupling surface 510, and each fixing hole 520 may be coupled to the lower fastening hole formed at the corresponding position of the mount frame 300 through the extension coupling module 800.

Accordingly, the coupling surface 510 is formed as a flat plane at a height at which the lower fastening holes are formed in the mount frame 300 provided thereabove.

The corresponding deformation surface 530 may be formed as a predetermined downward curved surface by gravity from the coupling surface 510 to the molding border 540.

In addition, the corresponding deformation surface 530 may be provided with at least one drainage port 550. The drainage port 550 is an opening having a predetermined size formed in the corresponding deformation surface 530, and in one embodiment of the present disclosure, the drainage port 550 may be formed in a rectangular size.

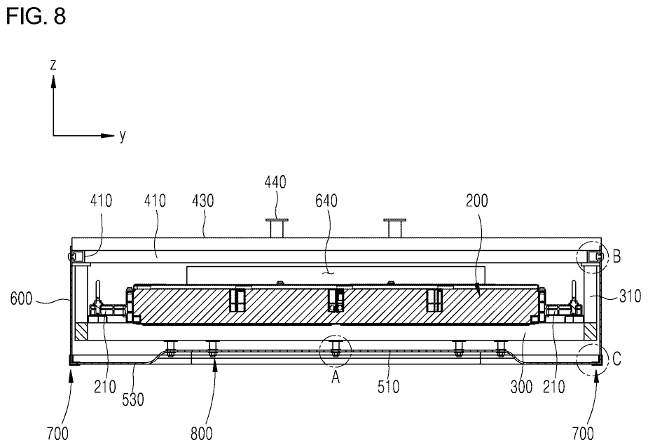

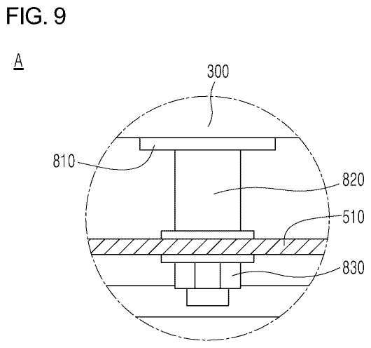

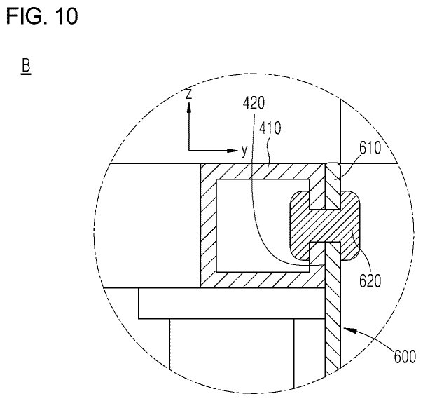

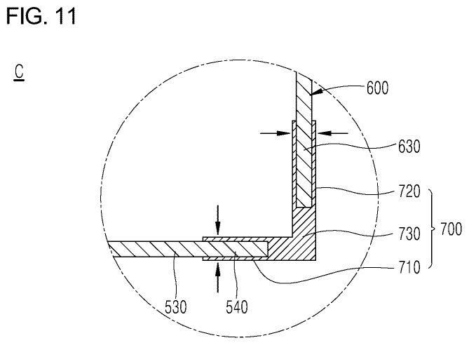

FIG. 8 is a cross-sectional view illustrating the internal structure of the fire response apparatus for roof-mounted electric vehicle batteries according to one embodiment of the present disclosure, FIG. 9 is a partial enlarged view illustrating portion A of FIG. 8, FIG. 10 is a partial enlarged view illustrating portion B of FIG. 8, and FIG. 11 is a partial enlarged view illustrating portion C of FIG. 8.

As shown in FIGS. 8 to 11, the extension coupling module 80 passes through the lower fastening hole formed in the lower end of the mount frame 300 and the fixing hole 520 formed in the coupling surface 510 so as to couple the mount frame 300 and the coupling surface 510.

The extension coupling module 800 includes adhesive surfaces 810, a spacer 820, and fixing units 830. The extension coupling module 800 may be configured such that a plurality of adhesive surfaces 810 and a plurality of fixing units 830 may be provided along the spacer 820 formed in a straight line, and an interval between objects to be coupled may be adjusted depending on the length of each spacer 820.

Thereby, each mount frame 300 may be coupled to other pack loading parts 120 in a stacked structure in the vertical direction.

The molding frame 700 is formed of a material having a high elastic modulus and high rigidity so that the external shape thereof is not easily deformed. The molding border 540 may be formed as a frame structure having a shape corresponding to the skeletal frame 400.

The molding frame 700 may be formed as a frame structure having a shape corresponding to the lower end of the water storage wall 600 that extends downward from the skeletal frame 400, i.e., the lower molding end 630.

The molding frame 700 includes a vertical coupler 720 having a thin opening that is opened upward, and a horizontal coupler 710 having a thin opening that is opened inward.

The vertical coupler 720 and the horizontal coupler 710 may be maintained at a certain angle through a high-rigidity shape maintainer 730.

The lower molding end 630 of the water storage wall 600 is inserted into the opening of the vertical coupler 720 to be coupled thereto.

The molding border 540 of the water storage barrier 500 is inserted into the opening of the horizontal coupler 710 to be coupled thereto.

Thereby, the battery pack 200 mounted on the mount frame 300 is located in a predetermined water storage structured formed around the perimeter and bottom of the battery pack 200.

Each of the vertical coupler 720 and the horizontal coupler 710 may be provided with a plurality of horizontal rivets or vertical rivets that passes through the lower molding end 630 or the molding border 540 inserted thereinto to be connected to the lower molding end 630 or the molding border 540.

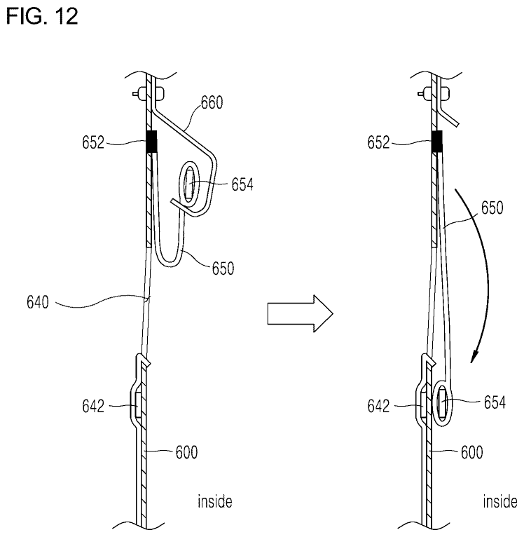

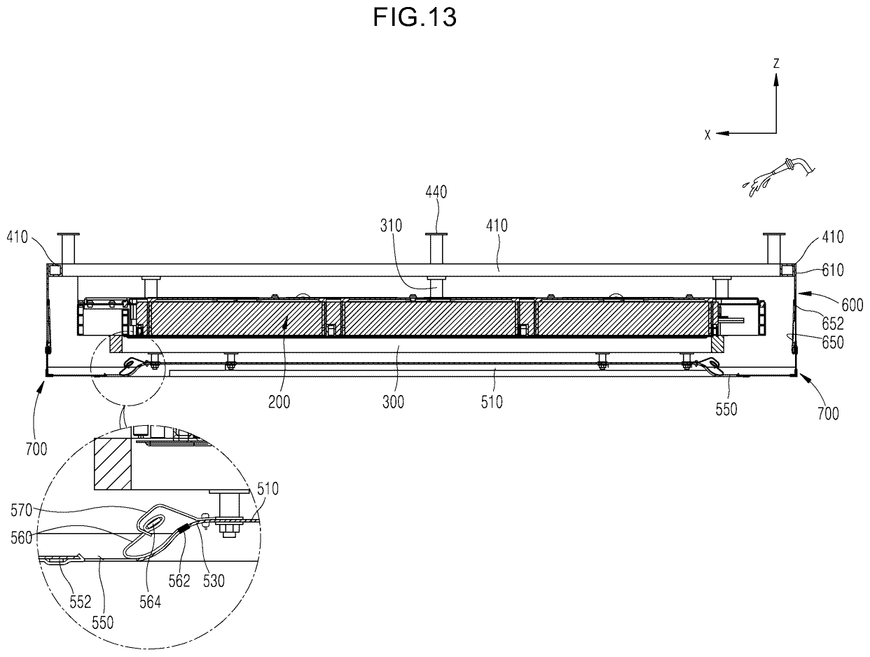

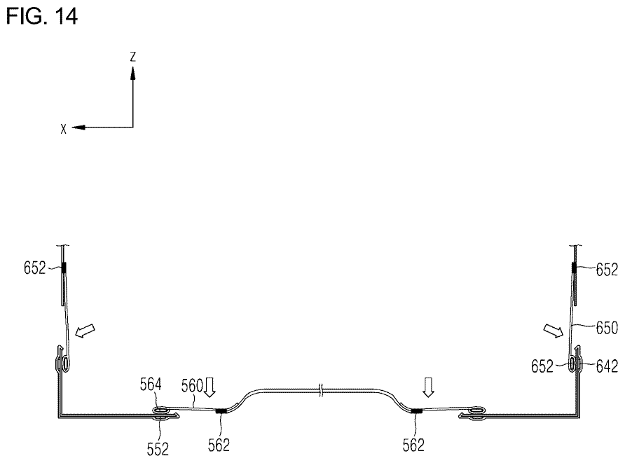

FIG. 12 is a partial cross-sectional view illustrating the structure of a shield 560 installed at the drainage port 550 in a roof-mounted electric vehicle battery according to one embodiment of the present disclosure, FIG. 13 is a cross-sectional view illustrating the structure of a water shield 650 installed at the open port 640 in the roof-mounted electric vehicle battery according to one embodiment of the present disclosure, and FIG. 14 is a schematic view illustrating a principle of forming a water storage space so that the extinguishing liquid is stored therein in the roof-mounted electric vehicle battery according to one embodiment of the present disclosure.

As described above, each battery pack 200 may be formed to be mounted on the roof 100 of the electric bus 1, and the pack loading part 120 on which each battery pack 200 is mounted may form a predetermined water storage structure.

The water storage structure is configured to smoothly perform ventilation and drainage without being sealed from the outside through the drainage port 550 and the open port 640.

In addition, a space capable of being structurally connected and coupled to the outside may be provided.

The fire response apparatus according to one embodiment of the present disclosure is operated so that the water storage structure capable of storing the fire extinguishing liquid at a predetermined temperature or higher is formed in each battery pack 200.

That is, as shown in FIG. 13, the water shield 650 may be provided at the open port 640 formed in the water storage wall 600. The water shield 650 is formed of a waterproof and thermally insulating fabric, and is formed to have a larger area than the open port 640.

The water shield 650 is coupled to the inner surface of the water storage wall 600 along the upper portion of the water storage wall 600 adjacent to the open port 640 through a wall connector 652. The wall connector 652 may be implemented in various forms, such as stitch processing and adhesion.

Under normal circumstances, the water shield 650 is rolled inward toward the wall connector 652 to maintain the open port 640 in the open state.

The water shield 650 is fixed so that the open port 640 is maintained in the open state through a melting member 660 that is ruptured at a predetermined temperature. Therefore, if the surrounding temperature is higher than or equal to the predetermined temperature, the binding force of the melting member 660 to the water shield 650 is removed, and the water shield 650 is unrolled to close the open port 640 from the inside.

A pair of strip springs that is provided in the vertical direction at both side ends of the water shield 650 may be provided. The strip springs allows the water shield 650 to be quickly spread in the state in which the binding force to the water shield 650 is removed.

In addition, an attractive adhesive part 642 may be installed on the outer surface of the water storage wall 600 along the lower end of the open port 640. In addition, a corresponding adhesive part 654 that forms attractive force with the attractive adhesive part 642 may be provided on the lower end of the water shield 650 at a height corresponding to the attractive adhesive part 642.

In addition, at least one drainage port 550 may be formed in the water storage barrier 500. The drainage port 550 is an open space having a predetermined size.

The drainage port 550 may be provided at an inclined position of the corresponding deformation surface 530 of the water storage barrier 500.

The shield 560 is coupled to the inner surface of the water storage barrier 500 at a position adjacent to a relatively high end of the drainage port 550 along a shield connector 562. The shield 560 may be formed of a waterproof and thermally insulating fabric, and strip springs may be coupled to both ends of the shield 560 in the length direction thereof.

The shield 560 is fixed in a rolled state toward the shield connector 562 inside the drainage port 550 through a melting member 570 that is ruptured at a predetermined temperature. When the surroundings are heated to the predetermine temperature, the melting members 570 is ruptured and binding force to the shield 560 is removed, the shield 560 is unrolled to close the space in which the drainage port 550 is formed.

An attractive force formation part 552 may be provided on an outer end of the drainage port 550 at a relatively low position, and an attractive force acting part 564 may be provided on the lower end of the shield 560 at a position corresponding to the attractive force formation part 552 formed at the drainage port 550. Because the attractive force acting part 564 is attached to the inner surface of the corresponding deformation surface 530 coupling surface 510 at the position corresponding to the attractive force formation part 552, it is possible to form a robust water storage structure that does not discharge the fire extinguishing liquid due to water pressure that may be generated as the fire extinguishing liquid fills the inside of the water storage structure.

As is apparent from the above description, according to the present disclosure, even if a battery pack system is provided on the upper end of a vehicle, such as an electric bus, a fire response apparatus may be manufactured in a relatively light and simple structure.

According to the present disclosure, if heat generation of a battery pack is detected even though the battery pack system has a structure that facilitates air circulation and dust discharge, the fire response apparatus may quickly respond to this situation and stabilize the battery pack system.

According to the present disclosure, the fire response apparatus may quickly detect heat generation of the battery pack system and rapidly respond to this situation, thereby being capable of preventing safety incidents that may occur due to the battery pack.

According to the present disclosure, the fire response apparatus employs a method of submerging the battery pack in the fire extinguishing liquid, which is the most effective countermeasure in the event of battery overheating or battery fire, thereby being capable of eliminating restrictions on response methods depending on the battery situation even in an electric battery-mounted system, such as an electric bus.

The effects of the present disclosure are not limited to those mentioned above, and other effects not mentioned herein may be clearly understood by those skilled in the art from the above description.

The embodiments of the present disclosure have been described above. It will be apparent that the described embodiments and drawings are merely illustrative and may be variously modified within the technical scope of the present disclosure.

The described embodiments should be considered as a part of the present disclosure, and the scope of the present disclosure is not limited to these embodiments.

The scope of the present disclosure should be determined depending on the technical idea described in the claims.

In addition, it is understood that, even if actions or effects according to a specific configuration are not explicitly described in the described embodiments, actions or effects capable of being predicted from the corresponding configuration are within the scope of the present disclosure.

What is claimed is:

1. A fire response apparatus for roof-mounted electric vehicle batteries, comprising:
a battery pack of an electric vehicle;
a mount frame configured to receive and support the battery pack such that the battery pack is electrically connected to the mount frame;
a plurality of vertical columns extending from the mount frame;
a skeletal frame coupled to the plurality of vertical columns;
a water storage wall being fixed to the skeletal frame and configured to surround an area beneath the skeletal frame; and
a controller configured to supply a fire extinguishing liquid to the water storage structure upon detection of a predetermined condition,
wherein the battery pack is disposed within the water storage structure.

2. The fire response apparatus according to claim 1, wherein the plurality of vertical columns extend upward from the mount frame along an outer circumference of the battery pack.

3. The fire response apparatus according to claim 1, wherein the skeletal frame is positioned above the battery back and configured to surround an area wider than the battery pack.

4. The fire response apparatus according to claim 1, further comprising a water storage barrier formed of a waterproof material, the water storage barrier having an outer circumference connected to a lower end of the water storage wall to form a bottom surface of a water storage structure.

5. The fire response apparatus according to claim 4, wherein the water storage barrier comprises a coupling surface having a predetermined area, the coupling surface being coupled to a lower end of the mount frame via a plurality of coupling modules to form a substantially flat surface, and wherein the plurality of coupling modules extend vertically downward and are coupled to a roof of a body of the electric vehicle.

6. The fire response apparatus according to claim 5, wherein the mount frame is stacked on another mount frame by coupling the coupling modules, which extend downward from the coupling surface, to upper ends of a plurality of vertical columns of the other mount frame.

7. The fire response apparatus according to claim 1, wherein the water storage wall comprises:
at least one open port formed in a side surface of the water storage wall and having a predetermined area; and
a water shield provided at an inner upper end of the open port and configured to close the open port when the surrounding temperature exceeds a predetermined value.

8. The fire response apparatus according to claim 7, wherein the water shield comprises:
a wall connector having an area wider than the width of the open port and coupled to a position on an inner surface of the water storage wall that is higher than the open port;
an attractive adhesive part provided along a lower end of the open port on an outer surface of the water storage wall;
a corresponding adhesive part provided in a horizontal direction at a lower end of the water shield, the corresponding adhesive part being configured to form an attractive force with the attractive adhesive part; and
a melting member configured to roll the water shield upward inside the water storage wall and to break at a predetermined temperature, thereby deploying the water shield.

9. The fire response apparatus according to claim 8, wherein the water shield further comprises a pair of strip springs provided at vertically opposite side ends of the water shield and configured to elastically restore the water shield to its deployed state when an external force is removed.

10. The fire response apparatus according to claim 1, wherein the skeletal frame comprises:
a support frame formed as a rectangular frame positioned above an upper portion of the battery pack; and
a fastening holder formed as a flat plane along an outer circumference of the support frame and provided with a plurality of fastening holes formed at predetermined intervals,
wherein the water storage wall comprises a plurality of coupling holes formed at an upper fastening end corresponding to the fastening holes, and the coupling holes are coupled to the fastening holes via fastening members.

11. The fire response apparatus according to claim 10, wherein the water storage wall further comprises a lower molding end formed with a predetermined width along its lower end.

12. The fire response apparatus according to claim 11, further comprising:
a water storage barrier having an outer circumference connected to a lower end of the water storage wall to form a bottom surface of a water storage structure;
the water storage barrier further comprises a molding border formed with a predetermined width along an outer circumference thereof; and
the apparatus further comprises a molding frame coupled horizontally to the lower molding end and coupled vertically to the molding border.

13. The fire response apparatus according to claim 11, wherein the molding frame is formed as a rectangular frame corresponding to the support frame and comprises:
a vertical coupler having an upwardly open longitudinal opening into which at least a portion of the lower molding end is inserted and coupled; and
a horizontal coupler having an inwardly open longitudinal opening into which at least a portion of the molding border is inserted and coupled.

14. The fire response apparatus according to claim 13, wherein the molding frame further comprises:
a plurality of horizontal rivets configured to pass through the lower molding end inserted into the vertical coupler to secure the coupling thereof; and
a plurality of vertical rivets configured to pass through the molding border inserted into the horizontal coupler to secure the coupling thereof.

15. The fire response apparatus according to claim 13, wherein the molding frame further comprises a high-rigidity shape maintainer having a high elastic modulus, the high-rigidity shape maintainer being configured to connect the vertical coupler and the horizontal coupler in a perpendicular manner within the rectangular molding frame.

16. The fire response apparatus according to claim 1, further comprising:
a water storage barrier having an outer circumference connected to a lower end of the water storage wall to form a bottom surface of a water storage structure,
wherein the water storage barrier further comprises a corresponding deformation surface provided between an outer circumference of the coupling surface and an outer circumference of the water storage barrier connected to the lower end of the water storage wall, the corresponding deformation surface including at least a partial section formed as a curved surface.

17. The fire response apparatus according to claim 16, wherein the corresponding deformation surface comprises:
a drainage port formed adjacent to the outer circumference of the coupling surface and having a predetermined size; and
a shield coupled to an upper side of the corresponding deformation surface along a side facing the coupling surface, the shield being configured to close the drainage port in a predetermined situation.

18. A vehicle comprising the fire response apparatus of claim 1.

19. A fire response apparatus for roof-mounted electric vehicle batteries, comprising:
a battery pack of an electric vehicle;
a mount frame configured to receive and support the battery pack such that the battery pack is electrically connected to the mount frame;
a plurality of vertical columns extending upward from the mount frame along an outer circumference of the battery pack;
a skeletal frame coupled to upper ends of the plurality of vertical columns, the skeletal frame being positioned above the battery pack and surrounding an area wider than the battery pack;
a water storage wall formed of a waterproof material, having an upper end fixed to the skeletal frame and configured to surround an area beneath the skeletal frame in all directions; and
a controller configured to supply a fire extinguishing liquid to the water storage structure upon detection of a predetermined condition,
wherein the battery pack is disposed within the water storage structure.

20. The fire response apparatus according to claim 19, further comprising a water storage barrier formed of a waterproof material, the water storage barrier having an outer circumference connected to a lower end of the water storage wall to form a bottom surface of a water storage structure.
